(19) United States
(12) Patent Application Publication
(10) Pub. No.: US 2010/0087953 A1
(43) Pub. Date: Apr. 8, 2010

(54) MERCHANDISING APPARATUS

(76) Inventor: BRENT DALE GARSON, Orange, OH (US)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 12/247,716

(22) Filed: Oct. 8, 2008

(51) Int. Cl. G06F 17/00

(52) U.S. Cl. 700/241; 221/155; 221/150 R; 700/231; 221/133

(57) ABSTRACT

An apparatus for use in dispensing containers of liquid includes a dispensing device having a container dispensing location and a plurality of container storage locations. A light source is disposed at the dispensing location. Light from the light source is transmitted through the bottom of a container at the dispensing location, through liquid disposed in the container, and through an outer side surface of the container.

### BACKGROUND OF THE INVENTION

The present invention relates to a new and improved merchandising apparatus for dispensing containers of liquid.

It is known to illuminate products in a merchandising apparatus to attract prospective purchasers to the products. Fluorescent, incandescent, and LED (light emitting diodes) light sources have been used in merchandising apparatus to illuminate products disposed therein. U.S. Pat. No. 6,550,269 entitled Dispensing Apparatus with Directional LED Lighting discloses the use of directional light emitting diodes positioned within a merchandising machine for illuminating products to be sold.

### SUMMARY OF THE INVENTION

The present invention relates to a new and improved merchandising apparatus for dispensing transparent and/or translucent containers of liquid and wherein a light source directs a light beam transverse to the bottom of the container of liquid and through the container of liquid to illuminate the container of liquid. When the transparent and/or translucent container and liquid are illuminated, the container and liquid form a light pipe and glow in an attractive, eye catching manner.

It is contemplated that the merchandising apparatus may have many different constructions. For example, the merchandising apparatus may be a glass front vending machine wherein a purchaser puts money or a credit card into the machine to pay for the selection, chooses a container to be vended and the selection is automatically vended by the machine. Alternatively, the merchandising apparatus may be a glass front merchandiser where the perspective purchaser opens a front door to remove a container of the purchasers selection from the apparatus. It is contemplated that the merchandising apparatus may include a plurality of tracks for prepositioning the containers relative to an opening such as a glass window, for viewing by perspective purchasers.

The present invention includes a plurality of different features. It is contemplated that these features may be utilized together in the manner disclosed herein. Alternatively, the features may be used separately or in various combinations with features from the prior art and other features disclosed herein. It should be understood that the invention is not limited to any one of the specific embodiments disclosed herein. This is because there are many ways in which the various features of the invention may be used together or separately and in which they may be changed from the specific embodiments disclosed herein.

### BRIEF DESCRIPTION OF THE DRAWINGS

The foregoing and other features of the present invention will become more apparent from a consideration of the following description taken in connection with the accompanying drawings wherein:

FIG. 1 is a simplified schematic illustration of a glass front merchandising apparatus in which the present invention is utilized;

FIG. 2 is a simplified schematic illustration, similar to FIG. 1, of the glass front vending machine with the front door opened to more fully illustrate arrays of containers to be dispensed;

FIG. 3 is a schematic perspective view of a plurality of tracks for supporting containers and having a light source for illuminating containers disposed at dispensing locations;

FIG. 4 is a (partially broken away schematic) front view, taken generally along the line 4-4 of FIG. 3, illustrating the relationship between light sources, tracks and containers at dispensing locations;

FIG. 5 is a schematic side view, taken generally along the line 5-5 of FIG. 3, illustrating a single track which holds a container in a dispensing location over a light source and holds a plurality of containers at storage locations;

FIG. 6 is a schematic cross sectional view, taken generally along the line of 6-6 of FIG. 5, illustrating the light source and the container at the dispensing location;

FIG. 7 is an enlarged schematic illustration of a portion of FIG. 5 and further illustrating the relationship between the light source and the container at the dispensing location;

FIG. 8 is a schematic illustration of controls for effecting energization of the light sources;

FIG. 9 is a schematic illustration of controls for controlling the illumination of containers disposed in an array of containers in a plurality of merchandising machines; and

FIG. 10 is a schematic illustration disclosing the use of light sources having multiple colors.

### DESCRIPTION OF SPECIFIC PREFERRED EMBODIMENTS OF THE INVENTION

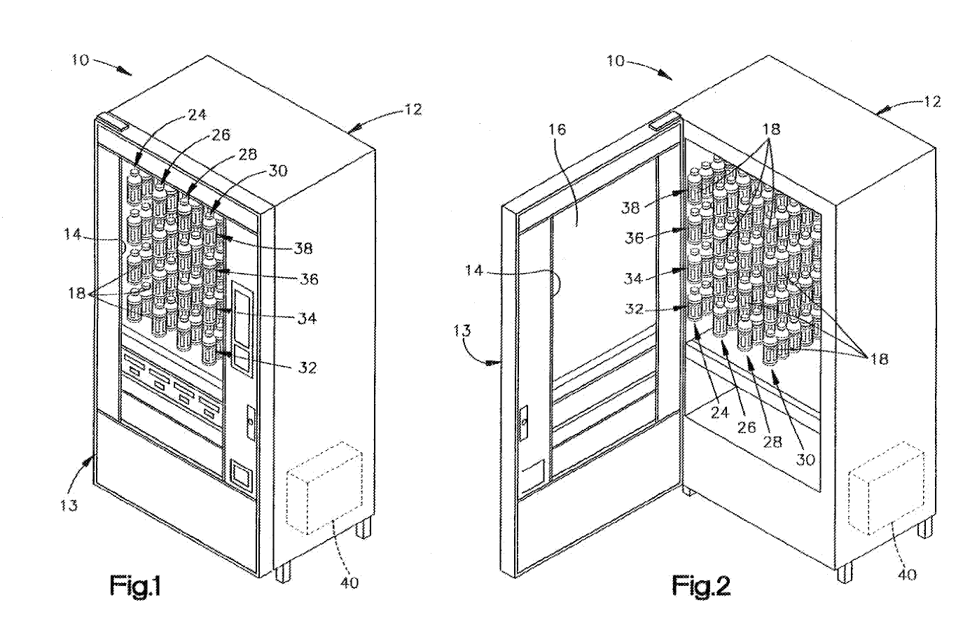

A merchandising machine or apparatus 10 constructed in accordance with the present invention is illustrated in FIGS. 1 and 2. The merchandising machine or apparatus 10 includes an enclosure 12 having a door 13. An opening or window 14 is disposed in the door 13. A transparent material, such as glass or plastic 16 (FIG. 2), is disposed in the opening 14 to enable a prospective purchaser to view containers 18 of liquid to be purchased.

A plurality of transparent and/or translucent containers 18 of transparent and/or translucent liquid are disposed in the enclosure 12 of the merchandising apparatus 10. The containers 18 are supported by a plurality of dispensing devices having a known construction. The dispensing devices support the containers 18 in a position within the opening 14 to enable a perspective purchaser to view the containers 18 to be purchased through the window or opening 14 in the enclosure 12.

The containers 18, as illustrated, are glass or plastic bottles made from transparent or translucent material. The liquid in the containers 18 is also transparent/translucent such as water, energy drinks, juices and soda. Other liquids disposed in other types of transparent or translucent containers may be used. Although the containers 18 are relatively rigid, flexible containers may be utilized if desired. These flexible containers 18 may be bags containing liquid and/or other material.

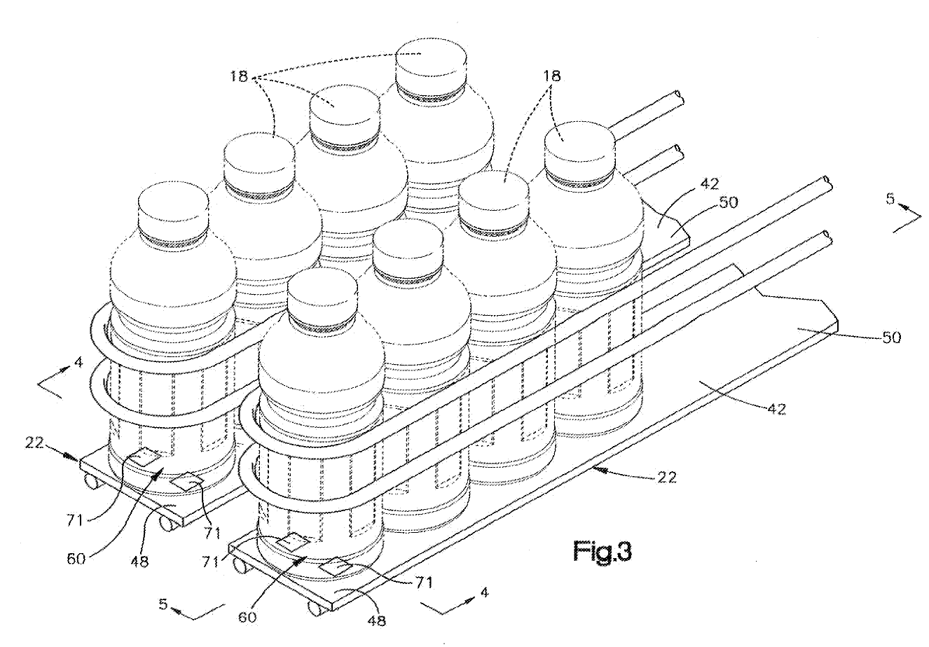

The dispensing devices include a plurality of tracks 22 (FIGS. 3-7). Each of the tracks 22 is operable to support a plurality of containers 18 to be sequentially vended from the tracks 22. Each of the tracks 22 supports a plurality of containers 18. The containers 18 on each of the tracks 22 are viewable by a potential purchaser through the window or opening 14 in the enclosure 12.

A refrigeration unit 40, schematically illustrated in FIGS. 1 and 2, is located within the enclosure 12 to cool the plurality of containers 18 of liquid located within the enclosure 12. Although the tracks 22 have been omitted in FIGS. 1 and 2 for purposes of clarity of illustration, it should be understood that each of the linear arrays of containers 18 is disposed on a track 22. Of course, dispensing devices have a construction different than the tracks 22 may be used if desired.

As is schematically illustrated in FIGS. 1 and 2, the containers 18 are supported in a 4×4 array for illustrative purchases. In the illustrative embodiment, the array is formed of four vertical columns 24, 26, 28 and 30 and four horizontal rows of containers 32, 34, 36 and 38. It should be appreciated that the array of containers 18 may include more or less than four rows and four columns depending on the particular construction of the merchandising apparatus 10.

The merchandising apparatus 10, as is illustrated in FIGS. 1 and 2, is a glass front merchandising machine which includes the door 13 having opening 14 therein which may be moved by a purchaser to its open position illustrated in FIG. 2 to enable the purchaser to remove containers 18 from the merchandising apparatus 10. While the present invention is illustrated schematically in a glass front merchandiser it should be appreciated that the invention could also be used in a glass front vending machine which is similar to a glass front merchandiser but which includes a mechanism for automatically dispensing a preselected container 18 from the array of containers located in the opening 14 in response to funds being inserted into the machine or a credit being applied to the coin mechanism by a perspective purchaser. In both a glass front merchandising machine and a glass front vending machine the purchaser views the bottles or containers 18 to be dispensed through opening 14 before making a selection.

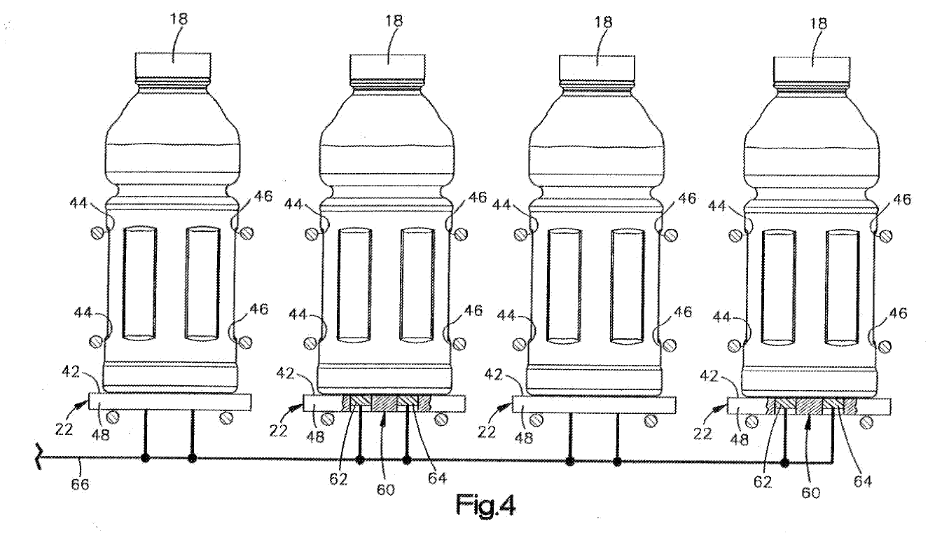

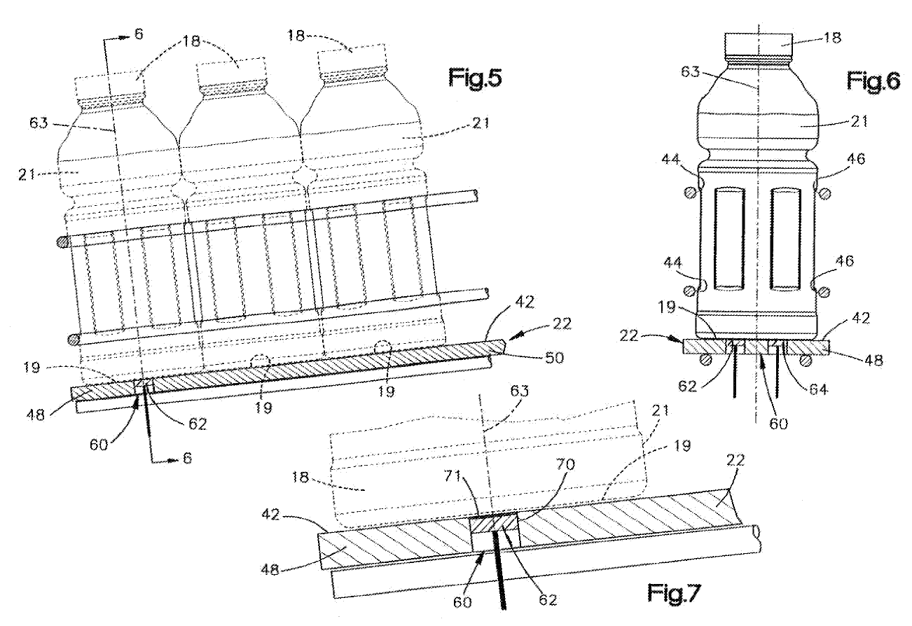

Each of the tracks 22 (FIGS. 3-5) is operable to support a plurality of containers 18 to be sequentially dispensed therefrom. Each track 22 includes an upper surface 42 and a pair of side surfaces 44 and 46 (FIG. 6). Each container 18 includes a bottom 19 for supporting the container in an upright position and a side surface 21. While side surface 21 is illustrated as a cylindrical surface, other configurations of containers could be utilized. For example, a rectangular container with planar side surfaces could be supported in tracks 22. The upper surface 42 of track 22 is adapted to engage with and support the bottom 19 of a container disposed in the track 22. Each of the side surfaces 44 and 46 of track 22, as is more fully illustrated in FIG. 4, engage with and guide the side 21 of the container 18 as the container 18 moves along the track 22.

Each track 22 includes a front end portion 48 (FIGS. 3 and 5) disposed adjacent to the opening 14 in the enclosure 12 and a rear end portion 50 which is spaced apart from the opening 14 in the enclosure 12. When a plurality of containers 18 such as bottles are supplied in the tracks 22, the containers are supported for movement sequentially from storage locations near the rear end portion 50 of track 22 to a dispensing location at the front end portion 48 of the track 22. The containers 18 located at the dispensing location at the front end portion 28 of each track 22 form the array of containers viewable in opening 14 and are the containers to be next dispensed from each of the tracks 22.

The front end portion 48 of track 22 is disposed lower than the rear end portion 50 so that the track 22 is inclined in a downwardly direction toward the opening 14. When a plurality of containers 18 are located on the track 22, the containers 18 will slide from storage locations toward the rear end portion 50 of the track 22 to the dispensing location at the front end portion 48 of the track due to the fact that the front end portion 48 of the track 22 is disposed lower than the rear 50 end portion of the track 22. It is also contemplated that the tracks 22 could be level and a pusher mechanism could be utilized to bias the containers 18 from the rear end portion 50 of track 22 toward the front end portion 48 of track 22 as the containers 18 are sequentially dispensed from the track 22. Pusher mechanisms to bias bottles in the track 22 are well known.

In the embodiment of the invention illustrated in FIGS. 3-6 the dispensing devices are formed of wire and the side surfaces 44 and 46 of each of the tracks 22 are located on the wires from which the dispensing devices is constructed. The upper surface 42 may be formed of plastic and can be supported within the track 22 by the wires of a support rack. It should be appreciated that other constructions of the support rack, track 22 and side surfaces 44 and 46 could be utilized. For example, sheet metal and/or molded plastic could be utilized which include an upper surface 42 for sliding supporting containers 18 and a side surface to position the container within the track 22. The racks and tracks 22 support and sequentially guide movement along the tracks 22 of a plurality of containers 18 of liquid to be vended.

At the front end portion 48 of each of the tracks 20 a light source 60 (FIGS. 3-7) is provided for illuminating a container 18 of liquid located in the dispensing location at the front end portion 48 of the track 22. The light source 60, when energized, shines a beam of light transverse to the bottom surface 42 of the track 22 and in an upwardly direction through the bottom 19 of a container of liquid 18 located in the track 22 at the front end portion 48 above the light source 60. The container 18 and the liquid in the container are transparent or translucent and act as a light guide to transmit the light from the light source 60 through the bottom of the container 18 and through the liquid therein.

The internal reflection of the light within the container 18 causes the container 18 and liquid therein to glow which creates a pleasing visual effect. The light from the light source 60 under the container 18 causes the container to be luminous. The visual effect can be viewed through opening 14 and utilized to entice a perspective purchaser of the product to be vended by the merchandising machine. The light source 60 can be controlled to turn off and on and to vary its intensity and color to entice a perspective purchaser.

The light source 60 can be located beneath the upper surface 42 (FIG. 7) of the track 22 and an opening 70 can be provided in the upper surface 42 through which the light source 60 directs light when the light source 60 is energized. Alternatively, an upper end of the light source 60 can be disposed at the upper surface 42 which supports the container 18. A suitable transparent covering 71 (FIG. 7) can protect the light source 60 from the bottoms of the containers 18 as they slide along the track 22. If desired, a transparent lens could be located in the opening 70 or molded into the upper surface 42 of the track 22 to enable the light source to illuminate in an upwardly direction through the opening 70 and through the bottom of the container 18 located on the track 22 above the light source 60.

The light source 60 is disposed at the front end portion 48 of the track near the front end of the track at a position in which the light source 60, when energized, will shine in an upwardly direction transverse to the upper surface 42 of track 22 and through the bottom 19 of a container 18 disposed at the front end portion 48 of the track 22. To this end the light source 60 is spaced apart from the front end of the track 22 by a distance which is less than the width of a container 18 to be vended (FIG. 5). When a container 18 is located at the front end portion 48 of the track in a dispensing location, the container is viewable by a perspective purchase through the opening 14 of the enclosure 10. The container 18 will have the light source 60 substantially centrally located under the bottom 19 of the container 18. The distance which the light source is spaced from the end of the track 22 is approximately one half the distance between the side surfaces 44 and 46.

In the embodiment of the invention illustrated in FIGS. 3, 4 and 6, a pair of light sources 62, 64 are utilized to effect illumination of a container 18 located at the dispensing location at the front end portion 48 of the track 22 above the light sources 62, 64. In one embodiment of the invention the light sources 62, 64 are surface mounted LED's (light emitting diodes). Surface mount, low profile, low heat emitting light emitting diodes can be used to illuminate the containers 18 and the liquid disposed therein. Such LED's may be obtained from Ledtech Electronics Corp. having a facility in Northridge Calif. Ledtech Part No. 19209-705 can be utilized as light source 62 and 64. This LED is a white light source having a viewing angle of approximately 120 degrees. Other LED's such as Ledtech Part No. AL19210-109 and/or incandescent sources could be located beneath the surface 42 of track 22 and utilized to illuminate the containers 18 through the bottom of the container.

The two light sources 62 and 64 are offset equal distances from a central axis 63 (FIG. 6) of a container 18 disposed at the dispensing location at the front portion 48 of the track 22. The central axis 63 of the container 18 goes through the center of the plurality of light sources formed by the light sources 62 and 64 which form the light source 60. It should be understood that a greater or lesser number of light sources may be provided to form the light source 60. For example, there may be three light sources forming the light source 60. Alternatively, there may be only one light source forming the light source 60.

In the illustrated embodiment of the invention the containers 18 are supported in an upright orientation. It is contemplated that the light source 60 may be oriented so as to illuminate a container 18, through its bottom 19, when the container is in a sidewise orientation. If desired, the container 18 which is illuminated by a light source may be disposed in a display, rather than a dispensing device. For example, the illuminated container 18 may be disposed in a display of various kinds of liquids which are available from the merchandising apparatus 10.

It is contemplated that fiber optics may be used to transmit light from a remote location to illuminate the container 18 located at the front end portion 48 of track 22. The fiber optics could terminate at the opening 70 (FIG. 7) in the track 22 and direct a light beam transverse to the upper surface 42 in an upward direction through the bottom of the container 18 to illuminate the container 18 and the liquid disposed therein. A single light source, remote from the tracks 22 (FIG. 4), may use fiber optics to conduct light to the front end portions 48 of a plurality of the tracks. The fiber optics may have ends which are aligned with the central axis 63 of a container at the dispensing location at the front end portion of the track 22. Alternatively, the fiber optics may have a plurality of ends disposed in an array which is aligned with the central axis 63 of a container 18 at the dispensing location at the front end portion of the track 22.

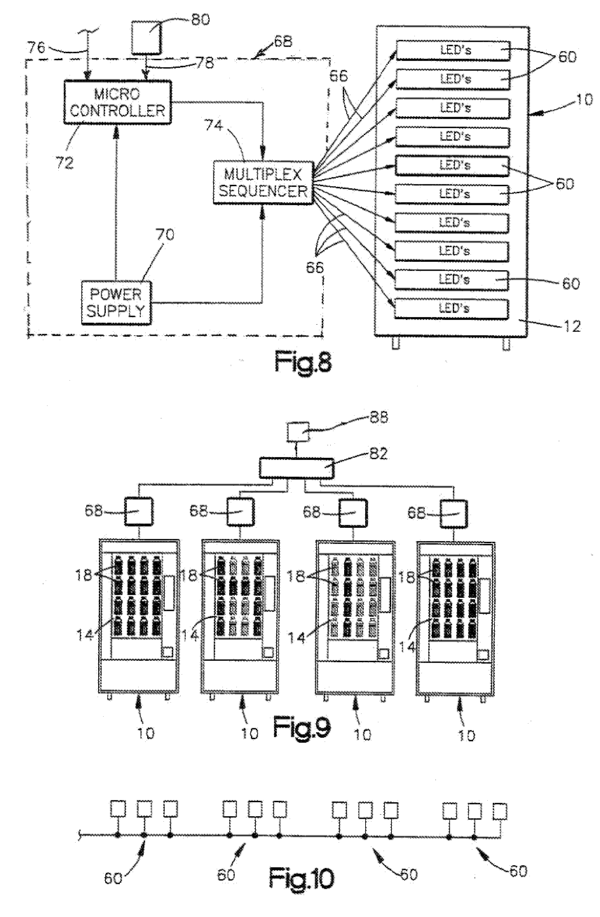

Each of the LED's 62, 64 in each of the tracks 22 are connected via lead 66 (FIG. 8) to a control 68 (FIG. 8) which selectively energizes the LED's 62 and 64 to effect illumination of selected containers 18 in the array of containers 18 located in the opening 14. The control 68 may effect illumination of all of the containers 18 in the array of containers 18 located in the opening 14, may effect illumination of light sources 60 in of selected columns 24, 26, 28 or 30 or may effect energization of light sources in selected rows 32, 34, 36 or 38. For example, all of the containers 18 on a track 22 may be illuminated by a plurality of light sources 60. Each of the light sources 62, 64 is individually addressable to enable the control 68 to energize individually selected light sources 60 to illuminate the containers 18 associated with the selected light sources.

As is more fully disclosed in FIG. 8, the control 68 includes a power supply 70, a microcontroller 72 and a multiplex sequencer 74. The power supply 70 is connected to a suitable source of power and provides a controlled source of voltage to the microcontroller 72 and the multiplex sequencer 74. The microcontroller 72 instructs the multiplex sequencer 74 to effect energization of selected light sources 60 in selected columns and/or rows to illuminate the containers 18 associated with the energized light sources 60. The multiplex sensor 74 may be a matrix driver, a parallel latch, or a shift register latch.

The microcontroller 72 has an input 76 which is adapted to receive programming instructions from the operator of the merchandising machine or apparatus 10 and an input 78 which can be connected to a sensor 80. The input 76 may receive a SD memory card which can be used to program the microcontroller 72. The operator of the apparatus 10 can program the SD memory card using an external computer and then insert the SD memory card in the input 76 of the microcontroller to instruct the microcontroller 72. The SD memory card may be utilized to create patterns, designs and multimedia effects by effecting illumination of selected containers 18 in the array of containers 18 disposed in the opening 14.

Alternatively, the microcontroller 72 may be programmed with a Secure Digital Micro Media card (SD/MMC) if desired. As another example, the microcontroller 72 may be programmed with a personal computer (PC) via an RS232 port or a micro controller programmer.

The input 78 is connected to a sensor 80. The sensor 80 may be a motion detector, a heat sensor, or a light and/or temperature sensor. The sensor 80 can be utilized to create an effect in response to a particular sensor sensing or not sensing a selected parameter. For example, a motion detectors may be utilized to create a pleasing visual display by effecting illumination of selected containers 18 in response to sensing movement in proximity to the merchandising machine 10. A heat detector such as an IR detector could also be utilized to create an effect in response to actuation. The sensor 80 could also include a light detector which can effect energization or deenergization of the light sources 60 in response to particular conditions. For example, if the sensor 80 indicates that the merchandising apparatus 10 is disposed in a dark area or that no ambient light is present, such as during closed hours of a store, the sensor can effect deenergization of all of the light sources 60 to save energy.

A motion detector could be utilized to effect deenergization of the light sources 60 when no one is in the vicinity of the merchandising machine 10 to save energy. In addition, the motion detector could then effect energization of selected light sources 60 when motion is detected to illuminate selected containers 18, to attract a potential purchaser.

The light sources 60 can be deenergized or can be energized at a reduced level of intensity in response to particular conditions sensed by the sensor 80. For example, it is possible to energize the light sources 60 at a fifty percent level of energization when no one is in the immediate vicinity of the merchandising apparatus 10 and then increase the energization to increase the intensity of the light sources 60 when someone approaches the machine 10 or comes within the vicinity of the merchandising machine 10. By reducing the degree of energization of LED light sources significant increases in the life of the LED's and significant energy savings can be achieved.

The control 68 is disclosed for illustrated purposes as being spaced apart from the merchandising apparatus 10 but can be incorporated within the enclosure 12.

FIG. 9 illustrates another embodiment of the invention wherein a plurality of merchandising machines or apparatus 10 are arranged in a bank of merchandising machines and a master control 82 provides an input to each of the microcontroller 72 in each of the controls 68 associated with each of the merchandising machine or apparatus 10. A master control 82 instructs each of the controls 68 to effect energization of preselected light sources 60 and illumination of their associated container 18 within each of the merchandising machines or apparatus 10. The master control 82 can coordinate the energization of selected light sources and the illumination of selected containers within the array of containers disposed within the opening 14 in each of the merchandising machine 10 to effect illumination of particular individual containers 18 and coordinate the energization and illumination of the container 18 in all of the machines.

For example it is possible to create designs that pass from machine to machine or to spell out words or phrases. FIG. 9 illustrates the master control 82 instructing the merchandising machines 10 to spell out “HI” in the middle two merchandising machines 10. The master control 82 includes an input (not illustrated) for programming the master control according to the desires of a user. The master control 82 may include a SD memory card slot which can be used to program the control 82. Additionally, a sensor input is provided in the master control 82 and a single or a plurality of sensors 88 such as those described with sensor 80, can be utilized.

FIG. 10 discloses an alternate embodiment of the invention wherein each of the light sources 60 includes multiple color light sources. Red, green, blue (RGB) Led's can be utilized in the embodiment illustrated in FIG. 10. Red, green, blue LED's include a red light source, a green light source and a blue light source, which can be separately addressed and energized to effect illumination of the containers 18 with various colors. For example any of the individual colors could be energized individually to create a red, green, or blue hue or combinations of the colors can be energized to create other hues including white. This allows illumination of the various containers 18 disposed in the array with various colors to create additional eye pleasing effects to entice a purchaser to purchase one of the containers 18 in the array of containers located in the opening 14 in the enclosure 10.

Having described the invention, the following is claimed:

1. An apparatus for dispensing containers of liquid each of which includes a bottom and a side surface, said apparatus including an enclosure for storing a plurality of containers to be dispensed,
an opening in said enclosure through which containers to be dispensed may be viewed,
a track located in said enclosure for supporting a plurality of containers to be sequentially dispensed, said track having a bottom surface which engages with the bottom of the containers to support the containers on said track and side surfaces which engage the container to position the container on said track,
said track having a front end portion disposed adjacent said opening in said enclosure and a rear end portion spaced from said opening in said enclosure,
said track being adapted to support a plurality of containers of liquid for sequential movement along said track from said rear end portion of said track to said front end portion of said track, with the container located on the front end portion of said track being disposed adjacent said opening in said enclosure and in a position to be dispensed from said track, and
a light source located adjacent to said front end portion of said track, said light source when energized shining a light beam upward and transverse to the bottom surface of said track and through the bottom of a container of liquid located at the front end portion of said track,
said light source when energized using the container of liquid as a light guide and being effective to illuminate the container of liquid located at the front end portion of the track.

2. An apparatus for dispensing container of liquid as defined in claim 1 wherein said light source is spaced from a front end portion of said track a distance which is less than the width of the container supported in said track to enable said light source, when energized, to illuminate the container at said front end portion of said track from directly beneath the container.

3. An apparatus for dispensing containers of liquid as defined in claim 2 wherein said light source is a LED.

4. An apparatus for dispensing containers of liquid as defined in claim 2 wherein said light source is a white LED.

5. An apparatus for dispensing containers of liquid as defined in claim 2 wherein said light source is a plurality of LEDs.

6. An apparatus for dispensing containers of liquid as defined in claim 5 wherein said plurality of LEDs include LED's of different colors which can be individually energized to effect illumination of the containers of liquid in different hues.

7. An apparatus for dispensing containers of liquid as defined in claim 2 further including a refrigeration unit to cool the plurality of containers of liquid located in said enclosure.

8. An apparatus for dispensing containers of liquid as defined in claim 4 wherein said LED when energized emits a light beam having a viewing angle of approximately 120 degrees.

9. An apparatus for dispensing containers of liquid as defined in claim 3 further including a control for effecting energization and deenergization of said LED to control the illumination of the container of liquid located at the front end portion of said track adjacent to said opening in said enclosure.

10. An apparatus as defined in claim 9 further including a sensor connected to said control for instructing said control to effect illumination of preselected light sources in response to said sensor sensing a preselect parameter.

11. An apparatus for dispensing containers of liquid, including, an enclosure for holding a plurality of containers of liquid to be dispensed,
an opening in said enclosure through which containers to be dispensed may be viewed,
a support in said enclosure for supporting and positioning in an array a plurality of containers to be dispensed,
a plurality of light sources, each of which is associated with one of said containers, each one of said light sources is energizable to shine light upward through the bottom surface of a container associated with said one light source to illuminate the container associated with said one light source,
each of said light sources using its associated container of liquid as a light guide to illuminate its associated container of liquid, and
a control for controlling the energization of each of the light sources to effect selective energization of each light source to illuminate selected containers in the array of containers.

12. An apparatus for dispensing containers of liquid as defined in claim 11 wherein each one of said light sources of said plurality of light sources includes an LED.

13. An apparatus for dispensing containers of liquid as defined in claim 11 wherein each one of said light sources includes a plurality of LEDs.

14. An apparatus for dispensing containers of liquid as defined in claim 11 wherein each of said light sources includes a white LED.

15. An apparatus as defined in claim 11 for dispensing containers of liquid wherein said array of containers includes a plurality of horizontal rows of containers and, a plurality of vertical columns of containers located in said enclosure in a position to be viewed through said opening.

16. An apparatus for dispensing containers of liquid as defined in claim 15 wherein said control is operable to effect energization of the light sources associated with a selected row of the plurality of containers positioned in said array of containers.

17. An apparatus for dispensing containers of liquid as defined in claim 15 wherein said control is operable to effect energization of the light sources associated with a selected column of the plurality of containers positioned in said array of containers.

18. An apparatus for dispensing containers of liquid as defined in claim 11 wherein said support includes a plurality of tracks each of which supports a plurality of containers to be sequentially dispensed, each of said tracks having a surface for engaging with the containers bottom surface to support the container on said track and a pair of side surfaces for engaging with and positioning the containers on said track, each of said tracks have a front end portion disposed adjacent said opening in said enclosure and a rear end portion spaced from said opening in said enclosure, each of said tracks being adapted to support a plurality of containers for sequential movement along said track from said rear end portion of said track to said front end portion of said track with the containers located in said front end portion of each track being disposed adjacent to said enclosure and in a position in which the containers may be dispensed from said track.

19. An apparatus for dispensing containers of liquid as defined in claim 18 wherein each of said containers of liquid is substantially centrally located between said side surfaces of said track

20. An apparatus for dispensing containers of liquid as defined in claim 18 wherein each of said light sources is spaced from said front end portion of said track a distance which is less than the width of the container of liquid supported in said track to enable said light source, when energized, to illuminate its associated container supported at the front end portion of said track from directly beneath the container.

21. An apparatus as defined in claim 11 further including a sensor connected to said control for instructing said control to control illumination of preselected light sources in response to said sensor sensing a preselect parameter.

22. A plurality of merchandising machines for dispensing transparent and translucent containers of liquid, each of the merchandising machines including an enclosure for storing a plurality of containers to be dispensed,
each of such enclosures including an opening through which containers to be dispensed may be viewed, a support located in such enclosure for supporting and positioning in an array a plurality of containers to be dispensed and a plurality of light sources each of which is associated with one of said containers in said array of containers, said light source, when energized, shining a light beam upward through the container of liquid associated with the particular light source to illuminate its associated container of liquid by using its associated container of liquid as a light pipe, and,
a control associated with each of the merchandising machines for controlling the energization of each of the light sources in its associated merchandising machine to effect selective energization thereof to illuminate selected container in said array of containers, and
a master control connected to each of said controls in the plurality of merchandising machine and providing signals to each of said controls to instruct each of said controls to selectively energize selected light sources to illuminate selected containers in the array of containers in each of the plurality of merchandising machine

23. A plurality of merchandising machines for dispensing containers of liquid as defined in claim 22 wherein each of said light sources is a LED which is positioned, when energized, to illuminate its associated container of liquid by emitting a beam of light in an upward direction through the bottom of its associated container of liquid.

24. An apparatus for use in dispensing containers which hold liquid and which have bottom and side surfaces, said apparatus comprising a dispensing device having a container dispensing location and a plurality of container storage locations, said dispensing device holds a single container at the dispensing location and a plurality of containers at storage locations, a container at a storage location being movable to the dispensing location upon movement of a container from the dispensing location, said dispensing device includes a light source which is disposed at the dispensing location and from which light is directed through a bottom of a container disposed at the dispensing location to cause light from said light source to be transmitted through liquid in the container disposed at the dispensing location and to be transmitted outwardly through the side surface of the container disposed at the dispensing location after the light has been transmitted through the bottom surface of the container disposed at the dispensing location and after the light has been transmitted through liquid in the container disposed at the dispensing location.

25. An apparatus as set forth in claim 24 further including an enclosure which encloses said dispensing device, said enclosure having a window through which the container disposed at the dispensing location is visible.

26. An apparatus as set forth in claim 24 wherein said dispensing device includes a track, said dispensing location being disposed at a first end portion of said track, said storage locations being disposed along said track in a direction away from said dispensing location.

27. An apparatus as set forth in claim 26 wherein said dispensing device includes first and second side surfaces which extend along opposite sides of said track and engage side surfaces of containers disposed on said track, said light source being spaced from an end of said track by a distance which is less than a distance between said first and second side surfaces.

28. An apparatus as set forth in claim 24 wherein said light source is capable of providing light of any one of a plurality of hues.

29. An apparatus for use in dispensing containers which hold liquid and which have bottom and side surfaces, said apparatus comprising an enclosure having a window through which a plurality of containers in said enclosure can be viewed, and a plurality of light sources disposed in said enclosure, light from each one of said plurality of light sources being directed through a bottom of an associated one of the containers which is visible through said window to cause light from the one light source of said plurality of light sources to be transmitted through liquid in the associated one of the containers and to be transmitted outwardly through a side surface of the associated one of the containers after the light from the one light source has been transmitted through the bottom surface of the associated one of the containers and through liquid in the associated one of the containers and through liquid in the containers.

30. An apparatus as set forth in claim 29 further including a plurality of dispensing devices disposed in said enclosure, each of said dispensing devices disposed in said enclosure, each of said dispensing devices holds a plurality of containers including a container at a dispensing location and a plurality of containers at storage locations, a container at a storage location being movable to the dispensing location upon movement of a container from the dispensing location.

31. An apparatus as set forth in claim 30 wherein light from each one of said light sources is directed through the bottom of a container at the dispensing location.
